(19) United States
(12) Patent Application Publication
(10) Pub. No.: US 2009/0188759 A1
(43) Pub. Date: Jul. 30, 2009

(54) Roping System for Elevators and Mine Shafts using Synthetic Rope

(76) Inventor: Rory Smith, El Cajon, CA (US)

Correspondence Address: FROST BROWN TODD, LLC, 2200 PNC CENTER, 201 E. FIFTH STREET, CINCINNATI, OH, 45202, US

(21) Appl. No.: 12/200,123

(22) Filed: Aug. 28, 2008

Related U.S. Application Data
(60) Provisional application No. 60/968,394, filed on Aug. 28, 2007.

(51) Int. Cl. B66B 11/08

(52) U.S. Cl. 187/254

(57) ABSTRACT

Versions of an elevator system are shown having a drive system including a driven sheave and a non-driven sheave. The driven sheave is configured to move an elevator car in a generally upward and downward direction. The non-driven sheave is configured to support the elevator car in the event of a loss of traction. The driven sheave is fixedly coupled to a drive shaft of the motor and the non-driven sheave is supported by the drive shaft but is freely rotatable relative to the drive shaft.

### PRIORITY

This application claims priority from U.S. Provisional No. 60/968,394, filed Aug. 28, 2007, entitled “Roping System for Elevators and Mine Shafts Using Synthetic Rope,” which is hereby incorporated by reference in its entirety.

### FIELD OF THE INVENTION

This application relates generally to elevator systems and, in particular, to drive systems for elevator cars.

### BACKGROUND

Benefits of synthetic rope when applied to elevators and mine lifts are known to those skilled in the art and include, low mass, long life, reduced sheave diameter, and reduced rope sway. However, synthetic ropes often have limitations such as having a tendency to rapidly part during a sustained loss of traction when an elevator car remains stationary. Synthetic ropes may also be more susceptible to general wear and tear during elevator operation. Wire ropes, as compared to synthetic ropes, may be able to better withstand damage inflicted during a sustained loss of traction. Wire ropes may also be more durable when subjected to the normal wear and tear caused by elevator operation. It would therefore be advantageous to provide the benefits of synthetic rope with the durability and long useful life associated with wire ropes.

### BRIEF DESCRIPTION OF THE DRAWINGS

It is believed the present invention will be better understood from the following description taken in conjunction with the accompanying drawings. The drawings and detailed description that follow are intended to be merely illustrative and are not intended to limit the scope of the invention.

FIG. 1 illustrates a front view of one version of an elevator system having a drive system, where the drive system is not shown to scale for descriptive purposes.

FIG. 2 illustrates a more detailed front view of the drive system of FIG. 1 shown having a driven sheave and a non-driven sheave.

FIG. 3 illustrates a more detailed front view of the driven sheave and non-driven sheave of FIG. 2.

FIG. 4 illustrates a left-side view of the driven sheave of FIG. 2.

FIG. 5 illustrates a right-side view of the non-driven sheave of FIG. 2.

FIG. 6A illustrates a side view of the driven sheave of FIG. 2.

FIG. 6B illustrates a cross-sectional view of the groove profile of the driven sheave of FIG. 2 taken along reference line A-A of FIG. 6A.

FIG. 6C illustrates a more detailed cross-sectional view of the groove profile of the driven sheave of FIG. 6B shown in the region illustrated by B in FIG. 6B.

FIG. 7A illustrates a side view of the driven sheave of FIG. 2.

FIG. 7B illustrates a cross-sectional view of the groove profile of the driven sheave of FIG. 2 taken along reference line C-C of FIG. 7A.

FIG. 7C illustrates a more detailed cross-sectional view of the groove profile of the driven sheave of FIG. 7B shown in the region illustrated by E in FIG. 7B.

### DETAILED DESCRIPTION

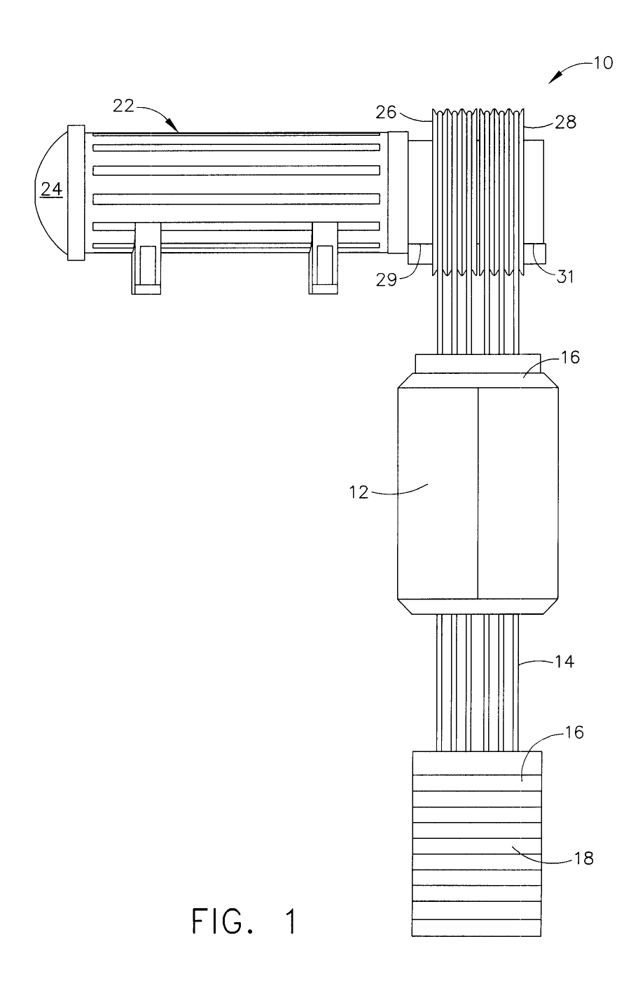

FIG. 1 illustrates a front view of one version of an elevator system (10). The elevator system (10) comprises an elevator car (12) positioned in a shaft (not shown) as is commonly known in the art. It will be understood that the elevator system (10) may be used for any suitable purpose including, for example, elevator or mining applications.

It is generally understood that residual breaking strength of synthetic fiber ropes is reduced by the number of bending cycles to which it is subjected. Synthetic fiber rope includes, for example, rope made of aramid fibers. The degree of reduction for any given tension is dependent on the friction factor of the sheave. Friction factor is a combination of coefficient of friction between the rope and the sheave material as well as the sheave groove profile. A groove that “pinches” the rope provides a higher friction factor.

Traction elevators are normally counterweighted. The counterweight reduces the traction required. This reduction applies equally to wire rope and synthetic rope.

This can be seen by reviewing Euler's equation for traction.

$$\frac{{T}_{1}}{{T}_{2}} \leq {e}^{f α}$$

Where:

T₁=the larger of two loads on a traction sheave such as a fully loaded elevator car.

T₂=the smaller of the two loads on the traction sheave such as the counterweight.

e=the base of natural logarithms

f=friction factor

α=the angle of rope contact over the sheave expressed in radians

An increase in friction factor is associated with a corresponding reduction in rope life. Versions described herein provide an elevator system that provides the benefits of synthetic and wire ropes while minimizing the limitations associated with each type of rope. Increasing the useful life of a system incorporating the benefits of both synthetic and wire ropes may improve the efficiency of the system and reduce costs associated with frequently replacing the suspension ropes.

As shown in FIG. 1, the elevator car (12) is supported by a plurality of ropes (14) which are connected at one end to the elevator car (12) and a first rope tension equalizer (16) and at the opposite end to a second rope tension equalizer (16) and a counterweight (18). It will be understood by those skilled in the art that any suitable rope tension equalizer, if present, may be used. The ropes (14) engage a drive system (22), which is responsible for driving the movement of the elevator car (12). In one version, the drive system (22) is affixed to the elevator shaft and remains stationary during operation. It will be understood that any suitable drive system may be used and positioned in any suitable manner.

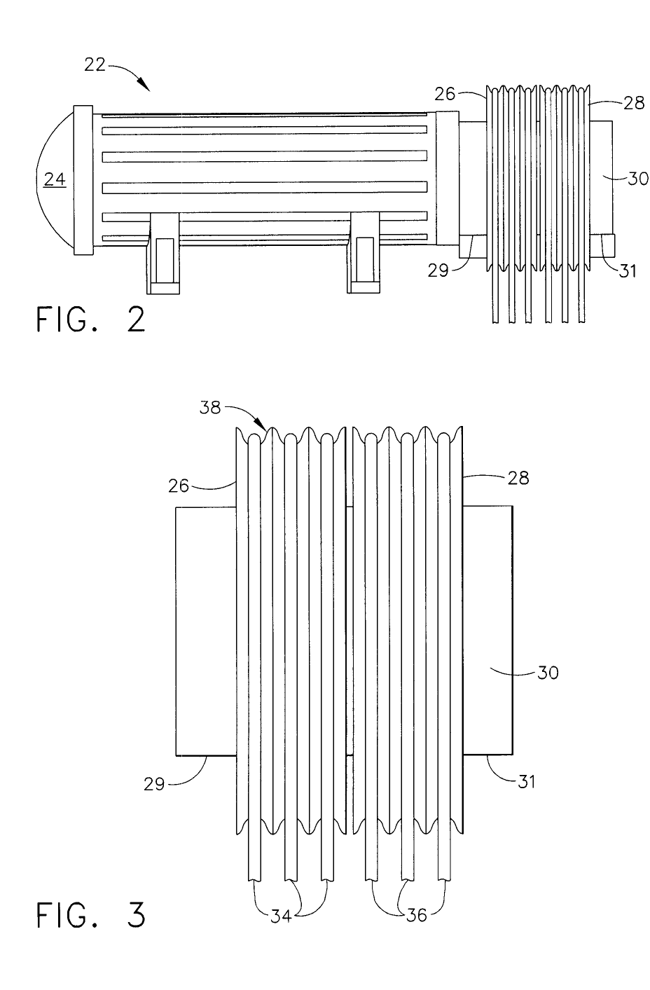

The drive system (22), depicted in more detail in FIGS. 2 and 3, comprises a motor (24), a driven sheave (26), and a non-driven sheave (28). The motor (24) drives the rotation of a shaft (30), where rotation of the shaft (30) in turn drives the rotation of the driven sheave (26). The rotation of the driven sheave (26) causes movement of the ropes, which translates into the raising or lowering of the elevator car (12) and the counterweight (18). Providing a drive system (22) with both a driven sheave (26) and a non-driven sheave (28) combines the strength and durability associated with wire rope with the numerous benefits associated with synthetic or aramid fiber rope.

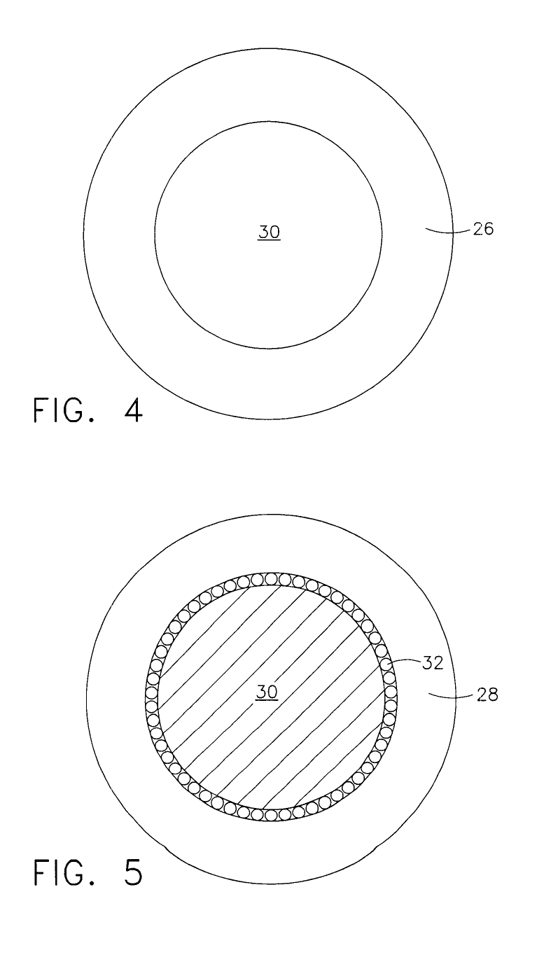

The shaft (30) engages both the driven sheave (26) and the non-driven sheave (28). In the illustrated version, the driven sheave (26) is positioned on the shaft (30) distal to the motor (24) and proximal to the non-driven sheave (28). The driven sheave (26) is rigidly connected to the shaft (30) as shown in FIG. 4. Thus, rotation of the shaft (30) correspondingly rotates the driven sheave (26). The non-driven sheave (28) is configured to rotate relative to the shaft (30) such that rotation of the shaft (30) is not transferred to the non-driven sheave (28). The non-driven sheave (28) is connected to the shaft (30) so it may rotate independently of the driven sheave (26) and the shaft (30). As shown in FIG. 5, in one version a plurality of bearings (32) are positioned between the shaft (30) and the non-driven sheave (28) to permit the non-driven sheave (28) to rotate independently of the shaft (30). Any suitable coupling between the non-driven sheave (28) and the shaft (30) is contemplated including, for example, a lubricated fitting.

In the version shown in FIG. 1, the ropes (14) engage the driven sheave (26) and the non-driven sheave (28) and are suspended from the drive system (22). The plurality of the ropes (14) engaged with the driven sheave (26), as shown in FIG. 2, are the traction ropes (34) which, in one version, are made of wire. The traction ropes (34) include a group of wire strands laid helically around a core and the strands include a number of individual wires laid about a central wire. In one version, the strands are manufactured out of steel, although any suitable wire rope may be used.

The suspension ropes (36) include the plurality of ropes (14) engaged with the non-driven sheave (28), as shown in FIG. 3. In one version, the suspension ropes (36) are synthetic ropes configured from aromatic polyamid or aramid materials. It will be understood that any suitable synthetic rope may be used where, for example, synthetic ropes may be used where each strand of the synthetic rope is layered with a protective coating. Likewise, synthetic ropes may be used where the plurality of strands is encased in a protective jacket. It will be appreciated that both the suspension ropes (36) and the traction ropes (34) act as suspension ropes for the elevator system.

In one version, a 1:1 ratio exists between the number of traction ropes (34) associated with the driven sheave (26) and the number of suspension ropes (36) associated with the non-driven sheave (28), although any suitable number of ropes and/or ratio of ropes may be used. The number of ropes used in any version of this system may depend upon a variety of factors including, but not limited to, the weight that the elevator car will support and the height of the elevator shaft. It will also be understood that various types of ropes may be engaged with the same sheave. For example, wire ropes may be used in combination with synthetic ropes for engagement with the non-drive sheave (28).

Versions of the elevator system provide the benefits of synthetic rope including, for example, low mass, long life, reduced sheave diameter, and reduced rope sway, with the benefits of wire rope. Associating the synthetic suspension ropes (36) with the non-driven sheave will subject them to fewer bending cycles and, thus, will increase their useful life. However, the suspension ropes (36) will still be operable as suspension ropes of the elevator car and may, for example, help reduce the overall rope sway of the suspension ropes. Although wire ropes may be damaged or even part when subjected to a loss of traction on a rotating sheave, the length of time needed to cause damage is several orders of magnitude longer than that of a synthetic rope. Thus, by associating the wire rope with the driven sheave (26) the elevator system will be subjecting the more durable suspension ropes to a greater number of bending cycles than the synthetic rope. This hybrid system may be an improvement over an elevator system incorporating all wire ropes, where the hybrid system may have reduced suspension rope weight and reduced rope sway. The hybrid system may be an improvement over an elevator system incorporating all synthetic rope, where the hybrid system may have an increased useful life by subjecting a more resilient wire rope to a greater number of bending cycles.

Because the driven sheave (26) is rigidly connected to the shaft (30), the traction ropes (34) correspondingly rotate with the driven sheave (26) and the shaft (30). However, in some instances, loss of traction will occur between the driven sheave (26) and the traction ropes (34). In these circumstances, the traction ropes (34) remain in the same position or relatively close to the same position while the shaft (30) and the driven sheave (26) continue to rotate. The continued contact during the loss of traction between the rotating driven sheave (26) and the non-moving traction ropes (34) may damage the traction ropes (34).

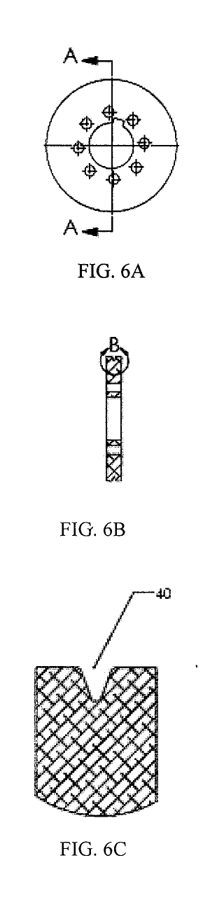

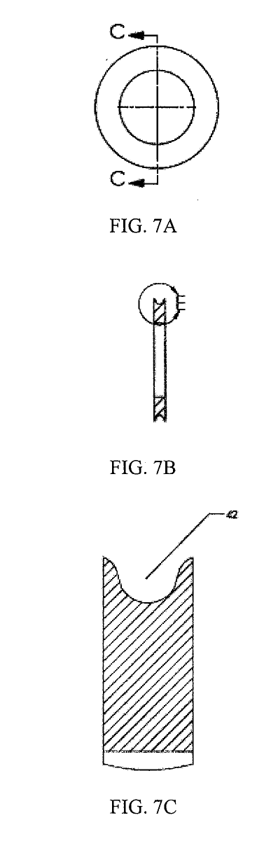

Unlike the driven sheave (26), the non-driven sheave (28) does not rotate during a loss of traction. The configuration of the non-driven sheave (28) allows the suspension ropes (36) to remain in a substantially stationary position during a loss of traction in the driven sheave (26). The lack of movement of the non-driven sheave (28) under such circumstances prevents the surface of the non-driven sheave (28) from continually rotating and wearing against the suspension ropes (36). Reducing frictional contact between the non-driven sheave (28) and the suspension ropes (36) may help prevent damage to the suspension ropes (36). In this manner a loss of traction does not create a loss of suspension. As shown in FIG. 2, sheaves (26), (28) comprise a plurality of groove profiles (38). For example, as seen in FIGS. 6A-6C, the driven sheave (26) may comprise V-shaped grooves (40). The V-shaped groove (40) may be configured to forcefully engage and/or pinch the traction rope (34). As seen in FIGS. 7A-7C, the non-driven sheave (28) may comprise U-shaped grooves (42). The U-shaped groove (42) may be configured to retain the suspension rope (36), but not to grip the rope as forcefully as if the sheave were driven. Because the sheave groove profiles of the suspension ropes (36) are not as aggressive as those grooves used for the traction ropes (34), the suspension ropes (34) may have a much longer life than the traction ropes (34).

The reduced force applied by the U-shaped grooves (42) to the suspension ropes (36) reduces the friction factor between the suspension ropes (42) and the non-driven sheave (28). The driven sheave (26) may have any groove or surface effect suitable to grip and drive the traction ropes (34) in an elevator system. The non-driven sheave (28) may have any suitable groove configured to retain the suspension ropes (42) therein. For example, a U-shaped groove (42), or any other shape, may increase the life of the rope (14) by reducing the friction factor between the groove and the rope. While the version shown illustrates wire rope engaging a V-shaped groove (40) and synthetic rope engaging a U-shaped groove (42), it will be understood that any suitable combination of grooves, rope, and sheaves may be used.

One replacement criteria for synthetic ropes is jacket failure. Since most synthetic ropes are generally jacketed with a material such as Nylon or Nomex, the jacket will fail before the residual strength of the rope has reached 60% of rated strength, which is the industry standard for replacement. In one version, the traction ropes (34) have a friction factor of, for example, 0.28 and then the suspension ropes (36) have a friction factor of 0.16. Because the friction factor of the traction ropes (34) is higher than that of the suspension ropes (36) the jacket failure of the traction ropes (34) will occur before the jacket failure of the suspension ropes (36). Since all ropes are generally replaced at the same time, the roping arrangement that is part of the illustrated example assures that the suspension ropes (34) will be replaced before a 60% residual strength level is reached.

As shown in FIG. 1, a plurality of brakes may be configured to engage the driven sheave (26) and the non-driven sheave (28). For example, an emergency brake (29) may be used with the drive system (22) to engage the driven sheave (26). A machine brake (31) may be engaged with the drive system (22) to engage the non-driven sheave (28). The brakes (29), (31) may be capable of limiting or otherwise stopping the movement of the shaft (30), the driven sheave (26), the non-driven sheave (28), or any combination thereof.

The following describes one sequence for operation of the version of the elevator system (10) described in FIG. 1. It will be understood that a plurality of sequences may exist. In this exemplary sequence, a waiting passenger activates a call signal. Activating a call signal causes a controller that governs the elevator system (10) to otherwise direct the elevator car (12) to respond to the call signal. The controller directs the drive system (22) to operate in a manner where the elevator car (12) travels to the floor where the passenger is waiting to be picked up. The motor (24) in the drive system (22) rotates the shaft (30), which in turn rotates the driven sheave (26) and causes the traction ropes (34) to slidably rotate along the driven sheave (26). Movement of the traction ropes (34) results in movement of the elevator car (12) in a vertical direction. In this version, the driven sheave (26) has V-shaped profiles (40) that engage the traction ropes (34) made of steel. The V-shaped profiles (40) pinch the traction ropes (34). This engagement helps ensure that minimal loss of traction occurs between the traction ropes (34) and the driven sheave (26).

The movement of the elevator car (12) in a vertical direction causes movement of the suspension ropes (36) and in turn rotation of the non-driven sheave (28). The suspension ropes (36), which are synthetic ropes, slidably rotate along the non-driven sheave (28) in a direction identical to that of the traction ropes (34). The friction forces produced from the suspension ropes (36) rotating along the non-driven sheave (28) cause rotation of the non-driven sheave (28). The non-driven sheave (28) includes U-shaped profiles (42) that reduce the force being applied to the suspension ropes (36). This reduction in force increases the life span of the suspension ropes (36).

The drive system (22) will continue to drive the elevator car (12) until it reaches its destination. If traction is lost between the traction ropes (34) and the driven sheave (26), the traction ropes (34) will remain motionless while the driven sheave (26) spins, thus creating wear on the traction ropes (34). However, if traction is lost, the suspension ropes (36) and the non-driven sheave (28) remain motionless despite the rotation of the driven sheave (26). Bearings (32), for example, engaged with the non-driven sheave (28) would allow the non-driven sheave (28) and the suspension ropes (36) to remain motionless. The absence of movement by both the non-driven sheave (28) and the suspension ropes (36) prevents sliding contact between the two components that might otherwise damage the suspension ropes (36), particularly where the suspension ropes (36) are synthetic ropes.

Having shown and described various embodiments of the present application, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, ratios, steps, and the like discussed above may be illustrative and not required. Accordingly, the scope of the present invention should be considered in terms of the following claims and is understood not to be limited to the details of structure and operation shown and described in the specification and drawings.

What is claimed is:

1. An elevator system comprising:
(a) an elevator car;
(b) a counterweight;
(c) a drive system, the drive system configured to move the elevator car, the drive system comprising; shaft;
(i) a motor;
(ii) a shaft, the shaft associated with the motor, wherein the motor is configured to rotate the shaft;
(iii) a first sheave fixedly secured to the shaft; and
(iv) a second sheave supported by the shaft, wherein the second sheave is rotatable relative to the shaft;
(d) a first rope, the first rope having a first end associated with the elevator car and a second end associated with the counterweight, wherein the first rope is wrapped around the first sheave; and
(e) a second rope, the second rope having a first end associated with the elevator car and a second end associated with the counterweight, wherein the second rope is wrapped around the second sheave.

2. The elevator system of claim 1, wherein the first rope is a wire rope.

3. The elevator system of claim 1, wherein the second rope is a synthetic rope.

4. The elevator system of claim 3, wherein the first rope is a wire rope.

5. The elevator system of claim 1, wherein the first sheave includes a first groove, the first groove being configured to engage the first rope.

6. The elevator system of claim 5, wherein the first sheave includes a plurality of grooves configured to engage a plurality of ropes.

7. The elevator system of claim 5, wherein the second sheave includes a second groove, the second groove configured to engage the second rope.

8. The elevator system of claim 7, wherein the second sheave includes a plurality of grooves configured to engage a plurality of ropes.

9. The elevator system of claim 7, wherein the first groove has a different configuration from the second groove.

10. The elevator system of claim 1, wherein the first groove is V-shaped and the second groove is U-shaped.

11. The elevator system of claim 1, wherein the second sheave is coupled with the shaft with a plurality of ball bearings.

12. An elevator system comprising:
(a) an elevator car;
(b) a counterweight;
(c) a drive system, the drive system configured to move the elevator car, the drive system comprising; shaft;
(i) a motor;
(ii) a shaft, the shaft associated with the motor, wherein the motor is configured to rotate the shaft;
(iii) a first sheave fixedly secured to the shaft; the first sheave having a plurality of grooves; and
(iv) a second sheave supported by the shaft, the second sheave having a plurality of grooves, wherein the second sheave is rotatable relative to the shaft;
(d) a first plurality of ropes, each of the first plurality of ropes having a first end associated with the elevator car and a second end associated with the counterweight, wherein each of the first plurality of ropes is wrapped around one of the plurality of grooves of the first sheave; and
(e) a second plurality of ropes, each of the second plurality of ropes having a first end associated with the elevator car and a second end associated with the counterweight, wherein each of the second plurality of ropes is wrapped around one of the plurality of grooves of the second sheave.

13. The elevator system of claim 12, wherein the second sheave is engaged with the shaft via a plurality of bearings.

14. The elevator system of claim 12, wherein the first plurality of ropes comprises wire rope.

15. The elevator system of claim 12, wherein the second plurality of ropes comprises synthetic rope.

16. The elevator system of claim 12, wherein the first plurality of ropes comprises the same number of ropes as the second plurality of ropes.

17. The elevator system of claim 12, wherein the plurality of grooves of the first sheave are differently configured from the plurality of grooves of the second sheave.

18. The elevator system of claim 12, wherein the plurality of grooves of the first sheave are V-shaped.

19. The elevator system of claim 12, wherein the plurality of grooves of the second sheave are U-shaped.

20. A drive system for an elevator comprising:
(a) a motor;
(b) a drive member, the drive member configure to be driven by the motor;
(c) a first sheave, the first sheave being supported by the drive member and fixedly coupled to the drive member;
(d) a second sheave, the second sheave being supported by the drive member and freely rotatable relative to the drive member.

21. The drive system of claim 20, wherein the first sheave is configured to drive a first rope and the second sheave is configured to retain a second rope.

22. The drive system of claim 21, where the first rope is a wire rope and the second rope is a synthetic rope.
